(19) United States
(12) Patent Application Publication
(10) Pub. No.: US 2024/0429794 A1
(43) Pub. Date: Dec. 26, 2024

(54) APPARATUS FOR MANUFACTURING ROTOR

(71) Applicant: TOYOTA BOSHOKU KABUSHIKI KAISHA, Aichi-ken (JP)

(72) Inventor: Masaki SUGIYAMA, Okazaki-shi (JP)

(73) Assignee: TOYOTA BOSHOKU KABUSHIKI KAISHA, Aichi-ken (JP)

(21) Appl. No.: 18/742,306

(22) Filed: Jun. 13, 2024

(30) Foreign Application Priority Data
Jun. 26, 2023 (JP) 2023-104351

(51) Int. Cl. H02K 15/03

(52) U.S. Cl. CPC H02K 15/03; H02K 2215/00

(57) ABSTRACT

An apparatus for manufacturing a rotor includes a regulating jig and an operation unit. The regulating jig includes a tubular jig body and a support member. The jig body includes segments segmented in the circumferential direction. In a regulated state, segment surfaces of the segments adjacent to each other are inclined at a fixed angle relative to the radial direction. One of either the support member or the segments include shaft portions arranged in correspondence with the segments, and the other one of either the support member or the segments include insertion portions into which the shaft portions are respectively inserted. In the regulated state, the insertion portions extend and incline to be positioned outward in the radial direction toward one side in the circumferential direction. The operation unit applies force for moving in the circumferential direction to one of either the support member or one of the segments.

### CROSS-REFERENCE TO RELATED APPLICATIONS

This application is based upon and claims the benefit of priority from prior Japanese Patent Application No. 2023-104351, filed on Jun. 26, 2023, the entire contents of which are incorporated herein by reference.

### BACKGROUND

### 1. Field

The present disclosure relates to an apparatus for manufacturing a rotor.

### 2. Description of Related Art

International Patent Publication WO2016/147211 describes a resin-filling device that fills magnet-housing holes of a rotor core with a thermoplastic resin. The resin-filling device disclosed in the above publication includes an upper die and a lower die.

The upper die includes an upper die body including an abutting surface that abuts the upper surface of the rotor core, and a fixing block that projects downward from the abutting surface and is inserted into a shaft hole of the rotor core.

The lower die includes a lower die body and a runner plate. The runner plate is attached to the upper surface of the lower die body. The runner plate has an upper surface on which the rotor core is placed. The lower die body includes a sprue passage that guides resin supplied from the nozzle of an injection molding machine. The runner plate includes branch passages and gate passages. The branch passages are connected to the downstream end of the sprue passage and extend radially toward each magnet-housing hole. The gate passages extend from the downstream end of each branch passage toward the end surface of the rotor core and are connectable to the magnet-housing holes.

In such a resin-filling device, molten thermoplastic resin flows into the sprue passage from the nozzle of the injection molding machine, and is then supplied to each magnet-housing hole through each branch passage and gate passage.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

When the magnet-housing holes are filled with the resin, the rotor core may be deformed radially outward from the filling pressure of the resin filling the magnet-housing holes. Thus, it is preferred that an apparatus for manufacturing a rotor include a regulating jig that restricts radially outward deformation of an outer circumferential surface by abutting the entire outer circumferential surface of the rotor core. In this case, in order to facilitate attachment and detachment of the regulating jig to and from the rotor core, it is preferred that the regulating jig include segments segmented in the circumferential direction of the rotor core, and that the segments be connected to each other by connecting members. In this case, as the number of segments increases, the regulating jig can easily compensate for variations in the outer diameter of the rotor core.

However, as the number of segments increases, there will be more connection members for the segments, requiring more time and effort when attaching and detaching the regulating jig.

In view of the above, in one general aspect, an apparatus for manufacturing a rotor is provided. The rotor includes a tubular rotor core including a central hole and magnet-housing holes, magnets accommodated in the magnet-housing holes, and a resin filling the magnet-housing holes and fixing the magnets to the rotor core. The apparatus includes a regulating jig, and an operation unit. The regulating jig includes a tubular jig body configured to restrict deformation of an outer circumferential surface of the rotor core by abutting the outer circumferential surface, and a support member supporting the jig body. An axial direction, a radial direction, and a circumferential direction of the rotor core are respectively referred to as an axial direction, a radial direction, and a circumferential direction. The jig body includes segments segmented in the circumferential direction. In a regulated state in which the segments form a tubular shape, segment surfaces of the segments adjacent to each other are inclined at a fixed angle relative to the radial direction.

One of either the support member or the segments include shaft portions arranged in correspondence with the segments and extending in the axial direction, and the other one of either the support member or the segments include insertion portions into which the shaft portions are respectively inserted to guide a relative movement of the segments with respect to the support member. In the regulated state, the insertion portions extend and incline to be positioned outward in the radial direction toward one side in the circumferential direction. The operation unit is configured to apply a force for moving in the circumferential direction to one of either the support member or one of the segments.

Other features and aspects will be apparent from the following detailed description, the drawings, and the claims.

### BRIEF DESCRIPTION OF THE DRAWINGS

FIG. 1 is a perspective view of a rotor manufactured using an apparatus for manufacturing a rotor according to one embodiment.

FIG. 2 is a cross-sectional view of the rotor of FIG. 1.

FIG. 3 is a cross-sectional view showing the apparatus for manufacturing a rotor according to the embodiment.

FIG. 4 is a plan view showing a regulating jig and an operation unit in a regulated state.

FIG. 5 is a plan view showing the regulating jig and the operation unit in a canceled state.

FIG. 6 is a cross-sectional view showing the apparatus for manufacturing a rotor according to a first modification.

FIG. 7 is a plan view showing a support member and the operation unit of FIG. 6.

FIG. 8 is a cross-sectional view showing the apparatus for manufacturing a rotor according to a second modification.

FIG. 9 is a plan view showing the support member of FIG. 8.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

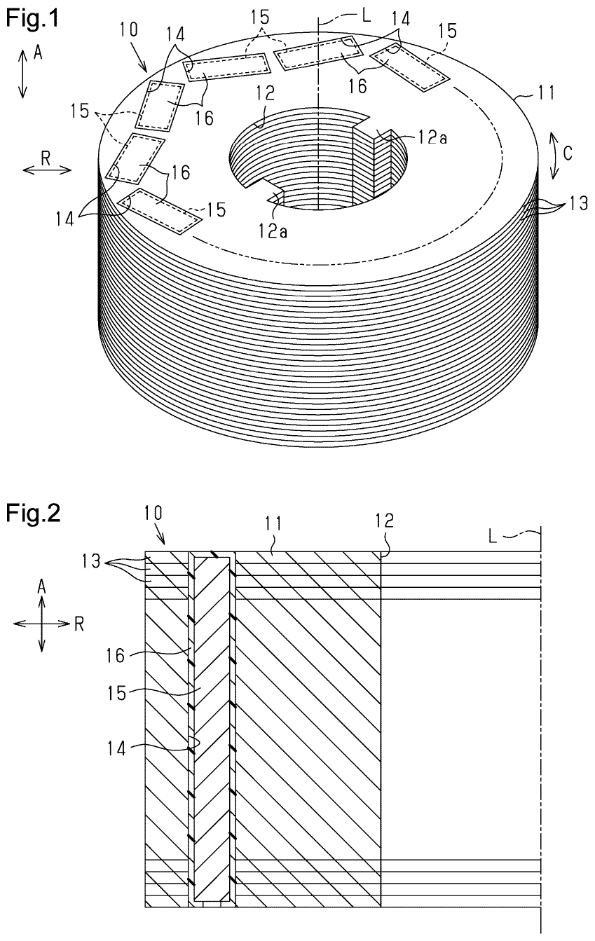

An apparatus for manufacturing a rotor according to one embodiment will now be described with reference to FIGS. 1 to 5.

A rotor 10 of a magnet-embedded motor that is manufactured using the apparatus for manufacturing a rotor (hereafter referred to as manufacturing apparatus 20) according to the present embodiment will be described with reference to FIGS. 1 and 2.

### Rotor 10

As shown in FIGS. 1 and 2, the rotor 10 includes a tubular rotor core 11 with a central hole 12 and magnet-housing holes 14, magnets 15 accommodated in the magnet-housing holes 14, and a resin 16 filling the magnet-housing holes 14 and fixing the magnets 15 to the rotor core 11.

In the following description, the axial direction, the radial direction, and the circumferential direction of the rotor core 11 will be respectively referred to as an axial direction A, a radial direction R, and a circumferential direction C.

The rotor core 11 is formed by a stack in which iron core pieces 13 are stacked. Each iron core piece 13 is made of a magnetic steel sheet.

Two key portions 12a project from the inner circumferential surface of the central hole 12 to be opposed to each other in the radial direction R (refer to FIG. 1).

The magnet-housing holes 14 are spaced apart from each other in the circumferential direction C.

As shown in FIG. 2, the central hole 12 and each magnet-housing hole 14 extend through the rotor core 11 in the axial direction A.

Each magnet 15 has a rectangular parallelepiped shape extending along an axis L.

The resin 16 is, for example, a thermoplastic resin. The resin 16 is preferably a liquid crystal polymer (LCP).

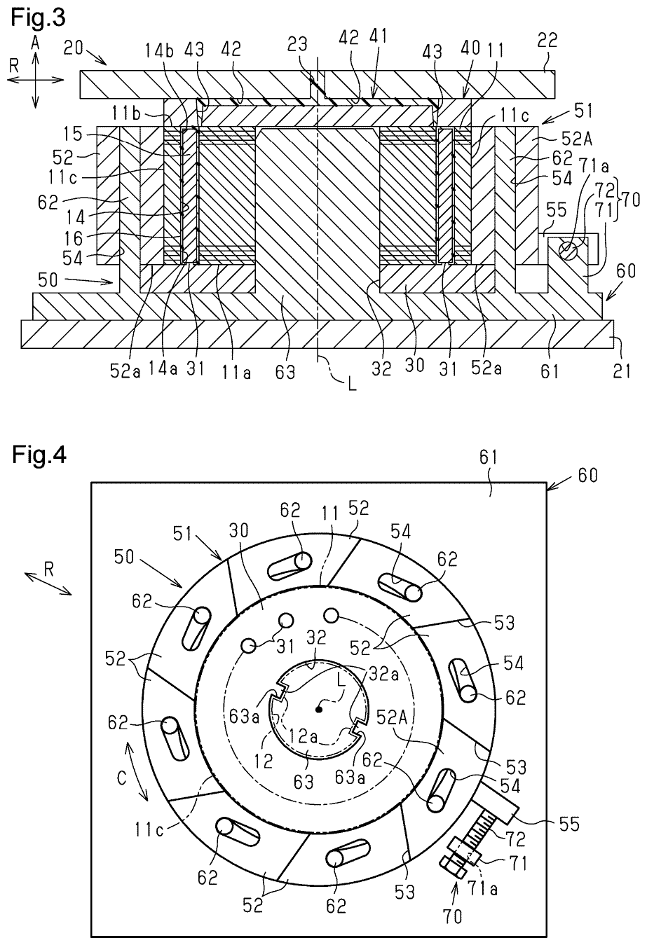

The manufacturing apparatus 20 will now be described with reference to FIGS. 3 to 5.

As shown in FIG. 3, the manufacturing apparatus 20 includes a first die 21, a second die 22, a support member 60, a first member 30, a jig body 51, an operation unit 70, and a second member 40.

### First Die 21 and Second Die 22

As shown in FIG. 3, the first die 21 is a fixed die. The second die 22, which is a movable die, is arranged above the first die 21 to be movable up and down.

The second die 22 includes a sprue passage 23 connected to a nozzle of an injection molding machine (not shown).

### Support Member 60

As shown in FIGS. 3 to 5, a support member 60 is arranged on the upper surface of the first die 21.

The support member 60 includes a substantially square and plate-shaped base portion 61 and a substantially columnar post portion 63. The base portion 61 is arranged on the upper surface of the first die 21. The post portion 63 projects upward from the central portion of the upper surface of the base portion 61.

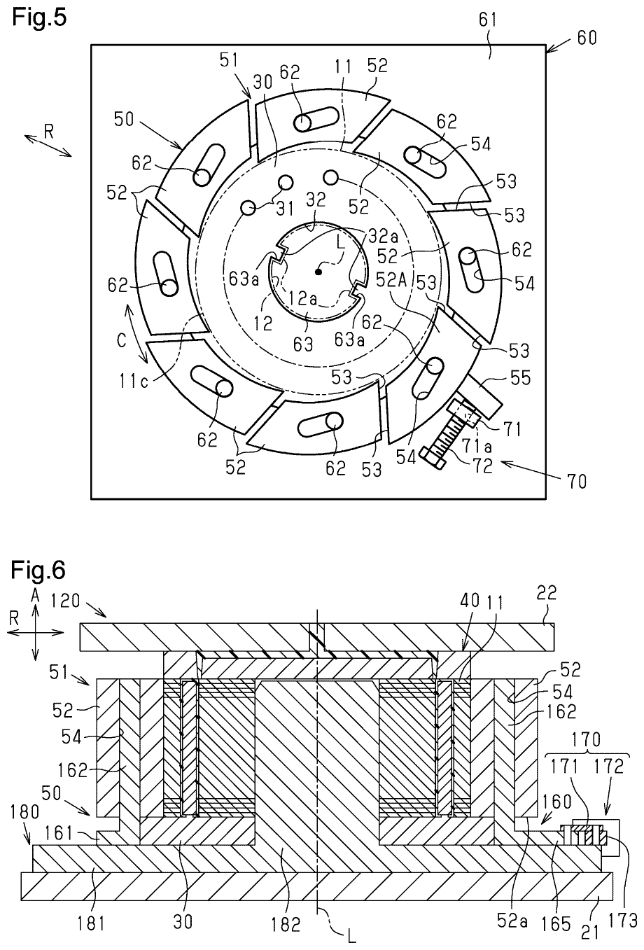

As shown in FIGS. 4 and 5, the post portion 63 includes two keyways 63a, which extend in the axial direction A, on the outer circumferential surface. The key portions 12a of the rotor core 11 are respectively inserted into the keyways 63a. The key portions 12a of the rotor core 11 are inserted into the keyways 63a of the post portion 63 to position the rotor core 11 in the circumferential direction C in relation to the base portion 61.

As shown in FIGS. 3 to 5, shaft portions 62 project upward from the upper surface of the base portion 61 at the outer side of the rotor core 11 in the radial direction R. The shaft portions 62 extend in the axial direction A. The shaft portions 62 are arranged at equal intervals on an imaginary circle with a center at the axis of the post portion 63, that is, the axis L of the rotor core 11. In the present embodiment, eight shaft portions 62 are provided.

### First Member 30

As shown in FIGS. 3 to 5, the disc-shaped first member 30 including a central hole 32 is arranged on the upper surface of the support member 60. The post portion 63 is inserted into the central hole 32. The inner circumferential surface of the central hole 32 includes two key portions 32a opposed to each other in the radial direction R (refer to FIGS. 4 and 5). The two key portions 32a are inserted into the two keyways 63a of the post portion 63.

The radius of the outer circumference of the first member 30 is less than the distance between the axis of the post portion 63 and the shaft portion 62.

As shown in FIG. 3, the rotor core 11 is placed on the upper surface of the first member 30. In a state in which the first member 30 abuts a lower end surface 11a of the rotor core 11, the upper surface of the first member 30 closes lower openings 14a of the magnet-housing holes 14.

As shown in FIGS. 3 to 5, the upper surface of the first member 30 includes projections 31 that raise the magnets 15 from the upper surface. The projections 31 are arranged at positions overlapping the magnet-housing holes 14 in the axial direction A.

### Jig Body 51

As shown in FIGS. 4 and 5, the jig body 51 is arranged on the upper surface of the first member 30. The jig body 51 includes segments 52 and has a tubular shape in its entirety. The jig body 51 restricts deformation of an outer circumferential surface 11c by abutting the outer circumferential surface 11c of the rotor core 11. In other words, the tubular jig body 51 includes the segments 52 segmented in the circumferential direction C. The segments 52 are arranged in correspondence with the shaft portions 62 of the base portion 61.

In the following, a state in which the segments 52 form a tubular shape will be referred to as a regulated state.

In the regulated state, segment surfaces 53 of the segments 52 adjacent to each other are inclined at a fixed angle relative to the radial direction R to be positioned outward in the radial direction R toward one side (front side in the clockwise direction in FIGS. 4 and 5) in the circumferential direction C.

The segments 52 include insertion portions 54 into which the shaft portions 62 are respectively inserted to guide the relative movement of the segments 52 with respect to the support member 60.

The insertion portions 54 extend through the segments 52 in the axial direction A. In other words, the segments 52 are respectively supported by the shaft portions 62 of the support member 60.

In the regulated state, the insertion portions 54 extend and incline to be positioned outward in the radial direction R toward one side (front side in the clockwise direction in FIGS. 4 and 5) in the circumferential direction C.

The segments 52 include lower end surfaces 52a that face the upper surface of the base portion 61 (refer to FIG. 3).

The segments 52 includes a single segment 52A that includes a projection 55 on the outer circumferential surface.

In the present embodiment, the regulating jig 50 is formed by the segments 52 and the support member 60.

### Operation Unit 70

As shown in FIGS. 3 to 5, the operation unit 70 includes a support portion 71 projecting upward from the upper surface of the base portion 61 at the outer side of the segments 52 in the radial direction R, and an operation member 72 supported by the support portion 71.

The support portion 71 includes an internal thread hole 71a extending in a tangential direction of the outer circumferential surface of the jig body 51 in the regulated state.

The operation member 72 includes an external thread portion threaded into the internal thread hole 71a and extends in the tangential direction. The distal end surface of the operation member 72 faces a surface of the projection 55 at one side (front side in the clockwise direction in FIGS. 4 and 5) in the circumferential direction C.

By threading the operation member 72 into the internal thread hole 71a, the projection 55 is pushed toward the other side in the circumferential direction C (rear side in the clockwise direction in FIGS. 4 and 5). This applies force for moving the segment 52A in the circumferential direction C to the segment 52A. Further, the operation member 72 restricts movement of the segment 52A to one side (front side in the clockwise direction in FIGS. 4 and 5) in the circumferential direction C.

### Second Member 40

As shown in FIG. 3, the second member 40 is arranged on an upper end surface 11b of the rotor core 11 to close upper openings of the magnet-housing holes 14, specifically, openings 14b of the magnet-housing holes 14 at an opposite side that is opposite to the opening 14a at one side. The second member 40 includes a passage 41 that supplies the resin 16 to the upper openings 14b.

The passage 41 includes branch passages 42 that are connected to the sprue passage 23 and extend radially outward in the radial direction R, and gate passages 43 that extend from the outer ends of the branch passages 42 in the radial direction R toward the lower surface of the second member 40 along the axis L. The gate passages 43 are arranged in correspondence with the magnet-housing holes 14.

A method of attaching the regulating jig 50 to the rotor core 11 and the operation of the present embodiment will now be described with reference to FIGS. 4 and 5.

First, as shown in FIG. 5, before attaching the regulating jig 50 to the rotor core 11, an operator rotates the operation member 72 to cancel pushing of the projection 55 with the operation member 72 (hereinafter referred to as canceled state). The operator moves the segments 52 along the insertion portions 54 and separates the segments 52 from each other by applying an external force to the segments 52 radially outward with their hand. Subsequently, the operator places the rotor core 11 on the upper surface of the first member 30 such that the post portion 63 is inserted into the central hole 12 of the rotor core 11 indicated by the long-dash double-short-dash line in FIG. 5.

Then, as shown in FIG. 4, when the operator rotates the operation member 72, the distal end of the operation member 72 pushes the projection 55 to move the segment 52A, which includes the projection 55, to the front side in the counterclockwise direction in FIG. 4. In this case, when the operation unit 70 applies force for moving the segment 52A in the circumferential direction C to the segment 52A, each segment 52 moves in the circumferential direction C and moves inward in the radial direction R based on the engagement between the insertion portion 54 and the shaft portion 62. In this case, the segment surfaces 53 of the segments 52 adjacent to each other are inclined at a fixed angle relative to the radial direction R. This avoids interference between the segments 52 adjacent to each other when the segments 52 are moved as described above. In this manner, the jig body 51 is reduced in diameter and the jig body 51 is attached to the outer circumferential surface 11c of the rotor core 11 when the operation unit 70 merely moves the single segment 52A in the circumferential direction C.

Then, as shown in FIG. 3, the magnets 15 are inserted into the magnet-housing holes 14 from the upper openings 14b. Subsequently, the second member 40 is placed on the upper end surface 11b of the rotor core 11. The rotor core 11, accommodating the magnets 15, is conveyed to the upper surface of the first die 21 together with the support member 60, the first member 30, the jig body 51, and the second member 40. The second die 22 is lowered so that the lower surface of the second die 22 abuts the upper surface of the second member 40.

Then, molten resin is supplied from the sprue passage 23 of the second die 22 to each branch passage 42. This fills the resin 16 into each magnet-housing hole 14 through each gate passage 43.

Then, the resin 16 is cooled to fix the magnet 15 to the rotor core 11.

The present embodiment has the following advantages.

(1) In the regulated state, in which the segments 52 form a tubular shape, the segment surfaces 53 of the segments 52 adjacent to each other are inclined at a fixed angle relative to the radial direction R. In the regulated state, the insertion portions 54 extend and incline to be positioned outward in the radial direction R toward one side (front side in the clockwise direction in FIGS. 4 and 5) in the circumferential direction C. The operation unit 70 applies force for moving the single segment 52A in the circumferential direction C to the single segment 52A.

Such a structure operates in the above-described manner and facilitates attachment of the regulating jig 50 to the rotor core 11.

(2) The segments 52 include the insertion portions 54. The support member 60 includes the base portion 61 and the shaft portions 62 projecting from the base portion 61. The operation unit 70 applies force for moving the single segment 52A in the circumferential direction C to the single segment 52A.

Such a structure applies force for moving the single segment 52A in the circumferential direction C to the single segment 52A to move each segment 52 in accordance with movement of the single segment 52A. This simplifies the structure of the operation unit 70 that applies force for moving each segment 52 in the circumferential direction C to each segment 52.

### Modifications

The present embodiment may be modified as described below. The present embodiment and the following modifications can be combined if the combined modifications remain technically consistent with each other.

A biasing member that biases the segments 52A toward the front side in the clockwise direction may be arranged. In this case, when pushing of the projection 55 with the operation member 72 is canceled, the biasing force of the biasing member biases the projection 55 toward the front side in the clockwise direction. This shifts each segment 52 into the canceled state shown in FIG. 5.

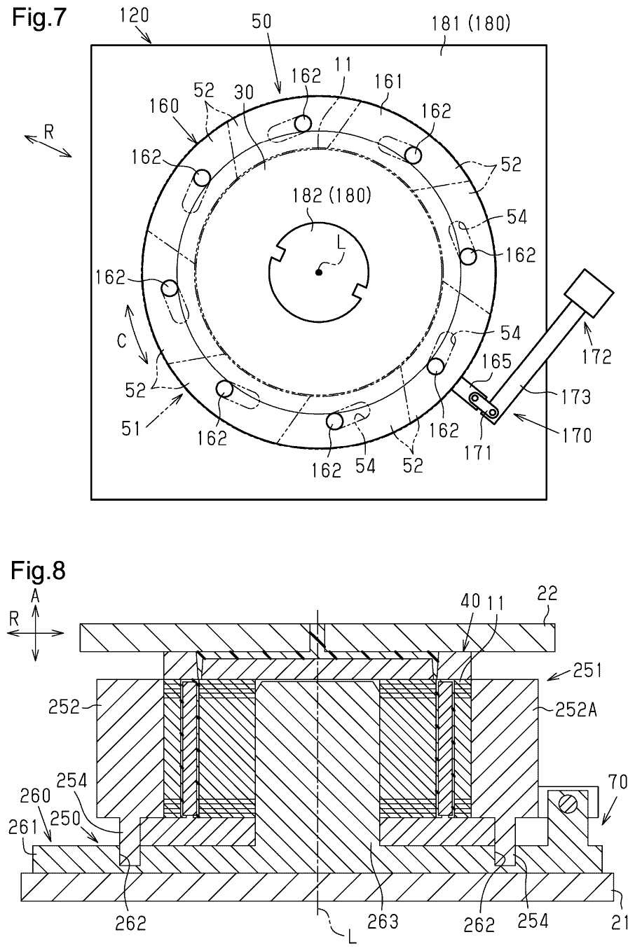

For example, as shown in FIGS. 6 and 7, a manufacturing apparatus 120 includes a first support member 180 including a first base portion 181 and a post portion 182 respectively corresponding to the base portion 61 and the post portion 63 of the above embodiment. A second support member 160 is arranged at the radially outer side of the first member 30. The second support member 160 includes an annular second base portion 161 that is opposed to the lower end surfaces 52a of the segments 52 in the axial direction A, and shaft portions 162 that project from the upper surface of the second base portion 161. A projection 165 projects radially outward from the outer circumferential surface of the second base portion 161. The second base portion 161 is arranged on the upper surface of the first base portion 181 to be rotatable about the axis L of the rotor core 11. The inner circumferential surface of the second base portion 161 slides on the outer circumferential surface of the first member 30. An operation unit 170 includes an actuator 172 that includes a drive shaft 173 extending in a tangential direction of the rotor core 11, and a link mechanism 171 that connects the drive shaft 173 and the projection 165. The actuator 172 is configured to change the amount of projection of the drive shaft 173 in the tangential direction of the rotor core 11. The operation unit 170 changes the amount of projection of the drive shaft 173 to apply force for rotating the second base portion 161 in the circumferential direction C to the second base portion 161 with the link mechanism 171. Thus, when the operation unit 170 applies force for moving the second support member 160 in the circumferential direction C to the second support member 160, each segment 52 moves in the circumferential direction C and moves inward in the radial direction R based on the engagement between the insertion portion 54 and the shaft portion 162. Thus, the jig body 51 is expanded or contracted when the operation unit 170 merely moves the second support member 160 in the circumferential direction C. This facilitates attachment of the regulating jig 50 to the rotor core 11.

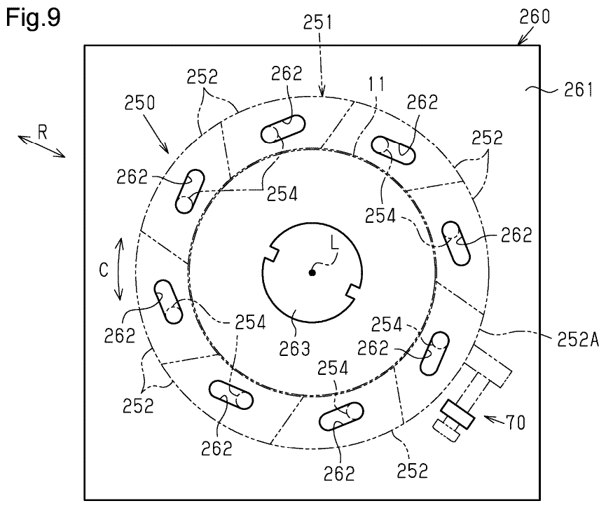

For example, as shown in FIGS. 8 and 9, a support member 260 includes a base portion 261 and a post portion 263 respectively corresponding to the base portion 61 and the post portion 63 of the above embodiment. Further, the shaft portions 62 are replaced by insertion portions 262 on the upper surface of the base portion 261. Shaft portion 254 projects downward from the lower surfaces of the segments 252. The insertion portions 262 are arranged at equal intervals in the circumferential direction C. The insertion portions 262 extend and incline to be positioned outward in the radial direction R toward one side (front side in the clockwise direction in FIG. 9) in the circumferential direction C. The operation unit 70 has the same structure as in the above embodiment. Thus, when the operation unit 70 applies force for moving a single segment 252A in the circumferential direction C to the single segment 252A, each segment 252 moves in the circumferential direction C and moves inward in the radial direction R based on the engagement between the insertion portion 262 and the shaft portion 254. In this manner, the jig body 251 is expanded or contracted when the operation unit 70 merely moves the single segment 252A in the circumferential direction C. This facilitates attachment of the regulating jig 250 to the rotor core 11.

In the present embodiment, the shaft portions 62 are integrated with the base portion 61. Instead, the first member 30 may be increased in diameter to face the entire portion of the lower end surface 52a of each segment 52, and the shaft portions 62 may be integrated with the first member 30. In this case, the first member 30 serves as a support member.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An apparatus for manufacturing a rotor, the rotor including a tubular rotor core including a central hole and magnet-housing holes, magnets accommodated in the magnet-housing holes, and a resin filling the magnet-housing holes and fixing the magnets to the rotor core, the apparatus comprising:
a regulating jig; and
an operation unit, wherein
the regulating jig includes a tubular jig body configured to restrict deformation of an outer circumferential surface of the rotor core by abutting the outer circumferential surface, and a support member supporting the jig body,
an axial direction, a radial direction, and a circumferential direction of the rotor core are respectively referred to as an axial direction, a radial direction, and a circumferential direction,
the jig body includes segments segmented in the circumferential direction,
in a regulated state in which the segments form a tubular shape, segment surfaces of the segments adjacent to each other are inclined at a fixed angle relative to the radial direction,
one of either the support member or the segments include shaft portions arranged in correspondence with the segments and extending in the axial direction, and an other one of either the support member or the segments include insertion portions into which the shaft portions are respectively inserted to guide a relative movement of the segments with respect to the support member,
in the regulated state, the insertion portions extend and incline to be positioned outward in the radial direction toward one side in the circumferential direction, and
the operation unit is configured to apply a force for moving in the circumferential direction to one of either the support member or one of the segments.

2. The apparatus according to claim 1, further comprising:
a first member configured to abut an end surface of the rotor core at one side to close openings of the magnet-housing holes at the one side; and
a second member configured to be arranged to close openings of the magnet-housing holes at an opposite side that is opposite to the openings at the one side, the second member including a passage configured to supply the resin to the openings at the opposite side, wherein
the segments include the insertion portions,
the support member includes the shaft portions and a base portion facing end surfaces of the segments at the one side in the axial direction, the shaft portions projecting from the base portion, and
the operation unit is configured to apply, to the one of the segments, a force for moving the one of the segments in the circumferential direction.

3. The apparatus according to claim 1, further comprising:
a first member configured to abut an end surface of the rotor core at one side to close openings of the magnet-housing holes at the one side; and
a second member configured to be arranged to close openings of the magnet-housing holes at an opposite side that is opposite to the openings at the one side, the second member including a passage configured to supply the resin to the openings at the opposite side, wherein
the segments include the insertion portions,
the support member includes the shaft portions and a base portion facing end surfaces of the segments at the one side in the axial direction, the shaft portions projecting from the base portion, and
the operation unit is configured to apply, to the base portion, a force for moving the base portion in the circumferential direction.

4. The apparatus according to claim 1, further comprising:
a first member configured to abut an end surface of the rotor core at one side to close openings of the magnet-housing holes at the one side; and
a second member configured to be arranged to close openings of the magnet-housing holes at an opposite side that is opposite to the openings at the one side, the second member including a passage configured to supply the resin to the openings at the opposite side, wherein
the support member includes the insertion portions and a base portion facing end surfaces of the segments at the one side in the axial direction, the insertion portions being arranged in the base portion, and
the segments include the shaft portions.
